(19) United States
(12) Patent Application Publication
(10) Pub. No.: US 2026/0011094 A1
(43) Pub. Date: Jan. 8, 2026

(54) MIXED REALITY SYSTEM AND METHOD

(71) Applicant: CUE Audio, Inc., Albany, TX (US)

(72) Inventors: Sean Hopkins, Clearwater, FL (US); Anthony Rago, Palm Springs, CA (US)

(21) Appl. No.: 19/261,045

(22) Filed: Jul. 7, 2025

Related U.S. Application Data
(60) Provisional application No. 63/668,037, filed on Jul. 5, 2024.
(60) Provisional application No. 63/670,502, filed on Jul. 12, 2024.

(51) Int. Cl. G06T 19/00; H04N 21/218; H04N 21/2187; H04N 21/414; H04N 21/81

(52) U.S. Cl. CPC G06T 19/006; H04N 21/21805; H04N 21/2187; H04N 21/41415; H04N 21/8146; G06T 2200/24

(57) ABSTRACT

A mixed reality method includes receiving a plurality of live camera feeds from a plurality of cameras in near real-time. The method further includes receiving one or more augmented reality (AR) content selections from a user based on AR content stored in an AR content database. The method includes generating a plurality of AR processed camera outputs for each live camera feed, where the one or more AR selections received from the user are synced across each AR process camera output. The method includes receiving a live AR processed feed selection from the user based on the plurality of AR processed camera outputs generated. The method includes generating one or more control signals configured to cause an event display device to display a three-dimensional graphic corresponding to the live augmented reality processed feed selection received.

### CROSS-REFERENCE TO RELATED APPLICATIONS

The present application claims the benefit under 35 U.S.C § 119(e) of U.S. Provisional Application No. 63/668,037, filed Jul. 5, 2024; and U.S. Provisional Application No. 63/670,502, filed Jul. 12, 2024, which are both incorporated by reference in their entirety.

### TECHNICAL FIELD

The present disclosure herein relates to video processing and, in particular, a system and method for mixed reality.

### BACKGROUND

Mixed reality (MR) systems can provide an enhanced viewing experience for users watching live events. Users may watch live displays of events such as concerts, sporting events, or conferences with augmented reality content overlaid on the display in real-time. However, typical MR activations require extensive manual set-up, additional camera tracking systems, expensive and bulky server grade personal computers, and complex real-time rendering, causing MR system to be under-utilized in the market. For example, existing MR activations often require a separate computer to process each camera angle to which augmented reality content is being overlaid on individually. Therefore, it is desirable to provide a system and method that cures one or more shortfalls of the previous approaches identified above.

### SUMMARY

A mixed reality system is disclosed, in accordance with one or more embodiments of the present disclosure. In embodiments, the mixed reality system includes: a controller communicatively coupled to a plurality of cameras, the controller including one or more processors configured to execute a set of program instructions stored in memory, the set of program instructions configured to cause the one or more processors to: receive a plurality of live camera feeds from the plurality of cameras in near real-time; receive one or more augmented reality content selections from a user based on augmented reality content stored in an augmented reality content database; generate a plurality of augmented reality processed camera outputs for each live camera feed of the plurality of live camera feeds, where the one or more augmented reality content selections received from the user are synced across each augmented reality process camera output of the plurality of augmented reality processed camera outputs; receive a live augmented reality processed feed selection from the user based on the generated plurality of augmented reality processed camera outputs; and generate one or more control signals configured to cause an event display device to display a three-dimensional graphic corresponding to the live augmented reality processed feed selection received.

A mixed reality system is disclosed, in accordance with one or more embodiments of the present disclosure. In embodiments, the mixed reality system includes: a plurality of cameras, where the plurality of cameras are configured to generate a plurality of live camera feeds of a live event in near real-time; an augmented reality content database including augmented reality content stored in the augmented reality content database; and a controller communicatively coupled to the plurality of cameras and the augmented reality content database, the controller including one or more processors configured to execute a set of program instructions stored in memory, the set of program instructions configured to cause the one or more processors to: receive the plurality of live camera feeds from the plurality of cameras in near real-time; receive one or more augmented reality content selections from a user based on the augmented reality content stored in the augmented reality content database; generate a plurality of augmented reality processed camera outputs for each live camera feed of the plurality of live camera feeds, where the received one or more augmented reality content selections received from the user are synced across each augmented reality process camera output of the plurality of augmented reality processed camera outputs; receive a live augmented reality processed feed selection from the user based on the generated plurality of augmented reality processed camera outputs; and generate one or more control signals configured to cause an event display device to display a three-dimensional graphic corresponding to the received live augmented reality processed feed selection.

A method is disclosed, in accordance with one or more embodiments of the present disclosure. In embodiments, the method includes: receiving a plurality of live camera feeds from a plurality of cameras in near real-time; receiving one or more augmented reality content selections from a user based on augmented reality content stored in an augmented reality content database; generating a plurality of augmented reality processed camera outputs for each live camera feed of the plurality of live camera feeds, where the one or more augmented reality content selections received from the user are synced across each augmented reality process camera output of the plurality of augmented reality processed camera outputs; receiving a live augmented reality processed feed selection from the user based on the plurality of augmented reality processed camera outputs generated; and generating one or more control signals configured to cause an event display device to display a three-dimensional graphic corresponding to the live augmented reality processed feed selection received.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures.

FIG. 1 illustrates a simplified block diagram of a prior art mixed reality system.

FIG. 2 illustrates a simplified block diagram of a mixed reality system, in accordance with one or more embodiments of the present disclosure.

FIG. 3A illustrates a flowchart depicting a mixed reality method, in accordance with one or more embodiments of the present disclosure.

FIG. 3B illustrates a conceptual flowchart depicting the mixed reality method, in accordance with one or more embodiments of the present disclosure.

FIG. 4A illustrates a simplified schematic of a graphical user interface, in accordance with one or more embodiments of the present disclosure.

FIG. 4B illustrates a simplified schematic of a graphical user interface, in accordance with one or more embodiments of the present disclosure.

FIG. 4C illustrates a simplified schematic of a graphical user interface, in accordance with one or more embodiments of the present disclosure.

FIG. 5A illustrates a simplified schematic of a graphical user interface, in accordance with one or more embodiments of the present disclosure.

FIG. 5B illustrates a simplified schematic of a graphical user interface, in accordance with one or more embodiments of the present disclosure.

FIG. 5C illustrates a simplified schematic of a graphical user interface, in accordance with one or more embodiments of the present disclosure.

FIG. 6A illustrates a simplified schematic of a graphical user interface, in accordance with one or more embodiments of the present disclosure.

FIG. 6B illustrates a simplified schematic of a graphical user interface, in accordance with one or more embodiments of the present disclosure.

FIG. 7 illustrates a simplified schematic of an event display device displaying a three-dimensional graphic, in accordance with one or more embodiments of the present disclosure.

FIG. 8A illustrates a simplified schematic of a graphical user interface, in accordance with one or more embodiments of the present disclosure.

FIG. 8B illustrates a simplified schematic of a graphical user interface, in accordance with one or more embodiments of the present disclosure.

FIG. 9 illustrates a simplified schematic of an event display device displaying a three-dimensional graphic, in accordance with one or more embodiments of the present disclosure.

FIG. 10A illustrates a simplified schematic of a graphical user interface, in accordance with one or more embodiments of the present disclosure.

FIG. 10B illustrates a simplified schematic of a graphical user interface, in accordance with one or more embodiments of the present disclosure.

FIG. 11 illustrates a simplified schematic of an event display device displaying a three-dimensional graphic, in accordance with one or more embodiments of the present disclosure.

FIG. 12 illustrates a simplified schematic of a graphical user interface, in accordance with one or more embodiments of the present disclosure.

FIG. 13A illustrates a simplified schematic of a graphical user interface, in accordance with one or more embodiments of the present disclosure.

FIG. 13B illustrates a simplified schematic of a graphical user interface, in accordance with one or more embodiments of the present disclosure.

FIG. 14 illustrates a simplified schematic of an event display device displaying a three-dimensional graphic, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

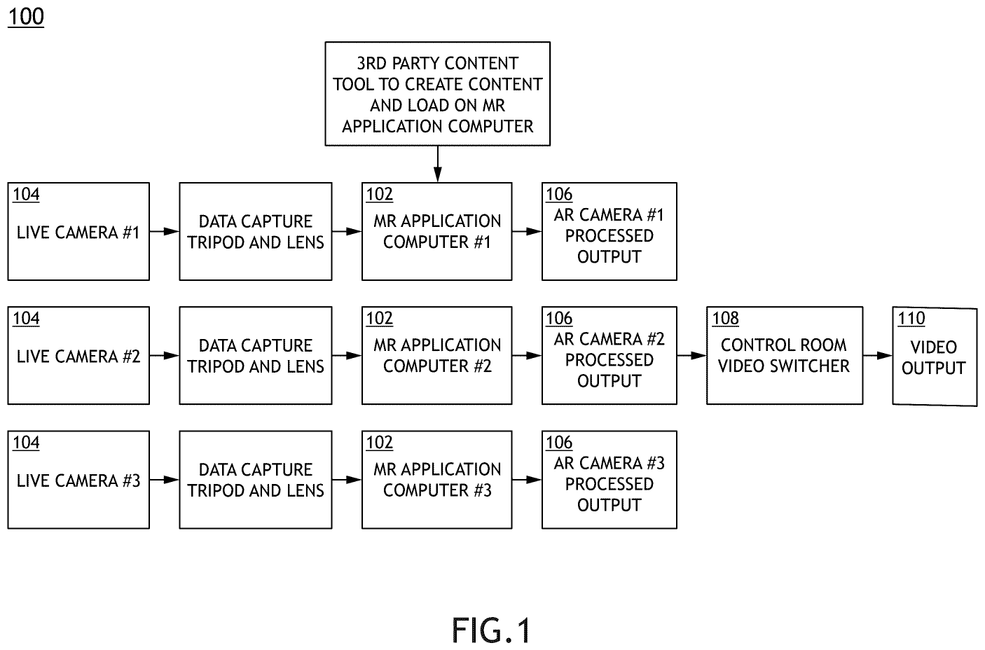

Mixed reality (MR) systems may be utilized to enhance the viewing experience of live events by augmenting content onto displayed video. Existing MR systems require time intensive manual setup, additional camera tracking systems, expensive and bulky server-grade computing machines, and complex real-time rendering software. For example, existing MR systems (such as the system 100 shown in FIG. 1) include a plurality of processors, where a separate processor is required for each live camera feed. In such example, each processor may receive a live camera feed associated with a respective camera 104. In this regard, as shown in FIG. 1, three live cameras 104 would require three separate computers 102. Each live camera feed is then processed to integrate the MR content into each of the live camera feeds to create a MR processed output 106 specific to each camera. Each MR processed output 106 may then be connected to a control room with a video switcher 108, where a specific MR processed output 110 may be chosen and displayed.

It is contemplated herein that existing systems which rely on multiple pieces of equipment/hardware are expensive and are complex to install and operate. Additionally, existing systems often utilize third-party content tools to create MR content, which may be uploaded to the MR application.

Embodiments of the present disclosure are directed to a system and method for mixed reality to allow a user to display a three-dimensional graphic along with near-real time video feed on a display device. For example, the system and method may be configured to process a plurality of camera feeds using a single computer and implement MR elements from an augmented reality content database across each camera feed in synchrony. In this regard, users are able to seamlessly switch between live processed camera feeds with the MR content seamlessly synched together on each output. By way of another example, the system and method may allow users to generate white label content on the fly without having to access third-party content tools, as required by existing MR solutions. For instance, the system and method may include a white label toolkit which allows for simplified customization of digital elements. The simplified customization allows users to upload videos, graphics, headshots, or the like and create MR elements, without using a third-party content creator. As such, the MR system and method of the present disclosure may create a MR solution for users who may have previously been deterred by the complex installations and high cost of existing MR systems.

It is contemplated herein that the processing of the MR system may be advantageously completed on a single computing device, such as a gaming system (e.g., with graphical processing unit (GPU) intensive processing and random-access memory (RAM)), thus decreasing the cost and complexity of installation and operation. Further, it is contemplated herein that external camera tracking systems (which are needed with existing systems) may not be required for the operation of the MR system of the present disclosure, since processing is done on a single computer.

It is noted herein that the MR system may be compatible with any suitable operating system such as, but not limited to, Windows, Mac, Linux, or the like. As such, the MR system and method of the present disclosure are able to be used on a wide variety of devices. Further, the MR system of the present disclosure may utilize one or more third-party gaming engines in order to render camera feeds in near-real-time, with less need for the currently available complex hardware integrations used with existing MR systems.

For purposes of the present disclosure, the term “mixed reality” refers to a blending of the physical real-world and computer-generated elements, unless otherwise noted herein. As used herein, “mixed reality” may include incorporating digital elements, such as a graphics, models, computer images, or the like, with an existing real-world environment (e.g., concerts, sporting events, or the like). It is contemplated herein that the terms “mixed reality” (MR) and “augmented reality” (AR) may be used interchangeably throughout, unless otherwise noted herein.

Reference will now be made in detail to the subject matter disclosed, which is illustrated in the accompanying drawings.

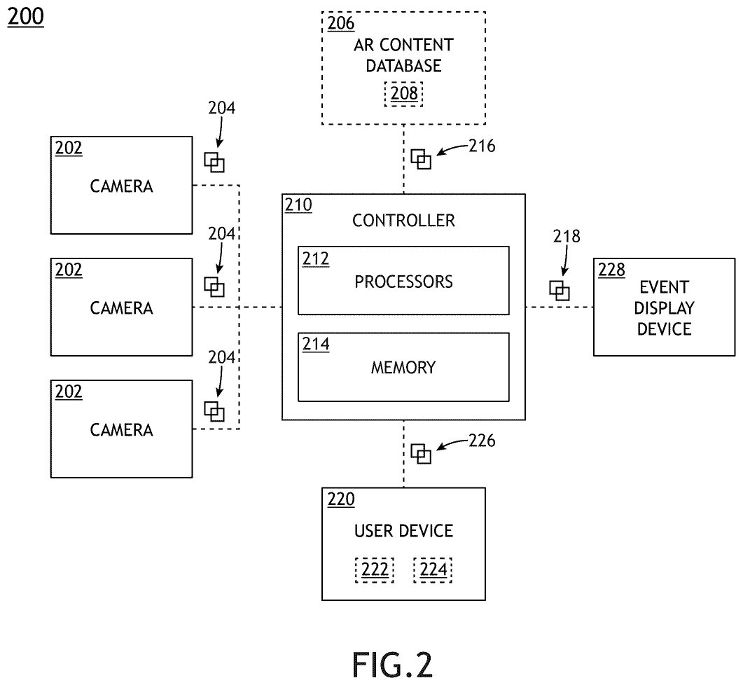

FIG. 2 illustrates a simplified block diagram of a mixed reality (MR) system 200, in accordance with one or more embodiments of the present disclosure.

The MR system 200 may include a plurality of cameras 202. The plurality of cameras 202 may capture a plurality of live camera feeds 204 of an event. In a non-limiting example, the plurality of cameras 202 may be used to capture live camera feeds 204 in real-time (or near real-time) of a live event. The live event may include any type of live event such as, but not limited to, a sporting event (e.g., baseball game, basketball game, football game, hockey game, or the like), a concert, a conference/seminar, a play, an awards show, or the like. In this regard, the live camera feed 204 may provide near real-time displayable video (or images) for at least one of the sporting event, concert, conference, or the like.

Each of the plurality of cameras 202 may be arranged at a camera specific angle/position based on the location and orientation of the respective camera. For example, the plurality of cameras 202 may be dispersed around the event to provide live camera feeds of a variety of different angles of the event (e.g., center, side, aerial, or the like). For instance, in a non-limiting example where the event is a sporting event, the plurality of cameras 202 may be dispersed at different places around the stadium, such that the plurality of cameras 202 may provide different live camera feed angles of the stadium.

The MR system 200 may include an augmented reality (AR) content database 206. For example, the AR content database 206 may provide a collection of AR content 208 that a user may select from. In one instance, the AR content 208 stored in the database 206 may include one or more three-dimensional graphics/animations. In another instance, the AR content 208 stored in the database 206 may include two-dimensional graphics/animations. In another instance, the AR content 208 stored in the database 206 may include one-dimensional graphics/animations.

As will be discussed further herein, the AR content 208 may be customized. For example, a user may customize the AR content 208 stored in the database 206 through a graphical user interface of the MR system 200. In one instance, a user may add customized text, animations, or the like to the AR content 208 stored in the database. In another instance, a user may change one or more parameters of the AR content 208 stored in the database 206 (e.g., color, size, font, or the like).

The MR system 200 may include a controller 210 communicatively coupled to each of the plurality of cameras 202. The controller 210 may include one or more processors 212 configured to execute a set of program instructions stored in memory 214. For example, the one or more processors 212 may be configured to receive the plurality of live camera feeds 204 from the plurality of cameras 202 in real-time (or near real-time). By way of another example, the one or more processors 212 may be configured to receive one or more AR content selections 216 from a user based on the AR content 208 stored in the AR content database 206. In one instance, the AR content database 206 may be stored in the memory on the controller 210. In another instance, the AR content database 206 may be stored in a remote database communicatively coupled to the controller 210. By way of another example, the one or more processors 212 may be configured to generate a plurality of AR processed camera outputs 218 based on each live camera feed 204 of the plurality of live camera feeds. For instance, the one or more AR selections 216 received from the user may be synced across each AR process camera output 218 of the plurality of augmented reality processed camera outputs. By way of another example, the one or more processors 212 may be configured to receive a live AR processed feed selection 226 from the user based on the generated plurality of AR processed camera outputs 218.

The MR system 200 may include a user interface device 220 that a user may operate to interact with the controller 210. For example, the user interface device 220 may include a user input device 222 and a display 224, where user interface device 220 may receive one or more user inputs via the user input device 222.

It is contemplated herein that the interactive user interface may be presented to users via an application-based system. For example, the user may interact with the controller 210 through the web-based application (app) For instance, the user may install the app on the user device 220 (e.g., a computer), and may thereby be able to interact with the controller 210 on their user device 220 through the app on the MR live platform. In this regard, the app may be compatible with windows operating systems (or another operating system). The user may launch the MR live platform on the user device to interact with the controller 210.

The MR system 200 may include a software developer kit (SDK) communicatively coupled to, or integrated with, one or more apps. The SDK may include source code or other computing instructions, which may be implemented within the controller 210. For example, the SDK implemented in the controller 210 may be configured to request and implement augmented reality content database features and functionality within the app. For instance, the SDK may allow a user to select AR content from the AR content database 206 and implement the AR content selections 216.

It is contemplated herein that the MR system 200 may also include a variety of software engines to allow complex real-time rendering. For example, the UNITY gaming engine may be integrated with the controller 210 to render the output content in near-real time without the need for complex hardware integrations.

The MR controller 210 may be communicatively coupled to an event display device 228. It is contemplated herein that the display device may include any device with the capabilities to display video. For example, the display device 228 may include a jumbotron, projector, television, or the like. In this regard, the display device 228 may be configured to display the three-dimensional graphics (or other type of AR graphics) to a large group of people (e.g., in a stadium, or other type of venue). By way of another example, the display device 228 may include a personal electronic device such as a smart phone, tablet, or the like configured to display the three-dimensional graphics to individuals present at the event or not present at the event (e.g., at home).

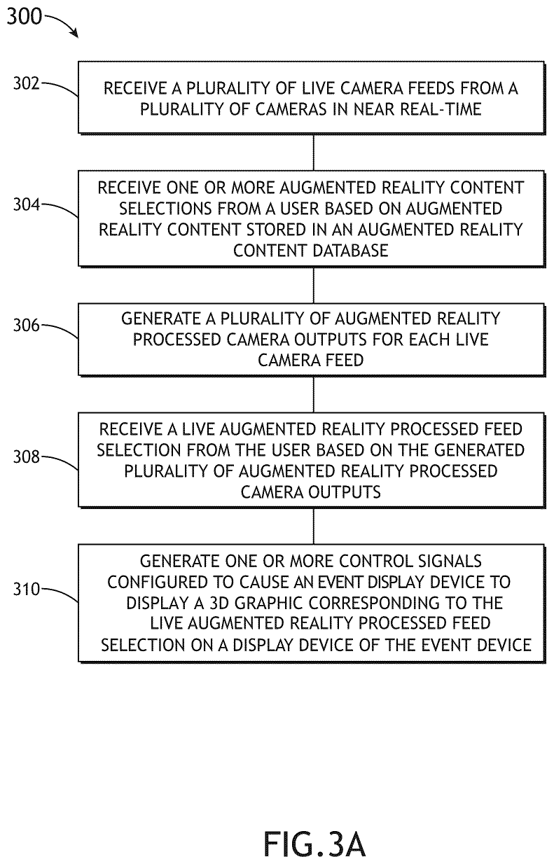

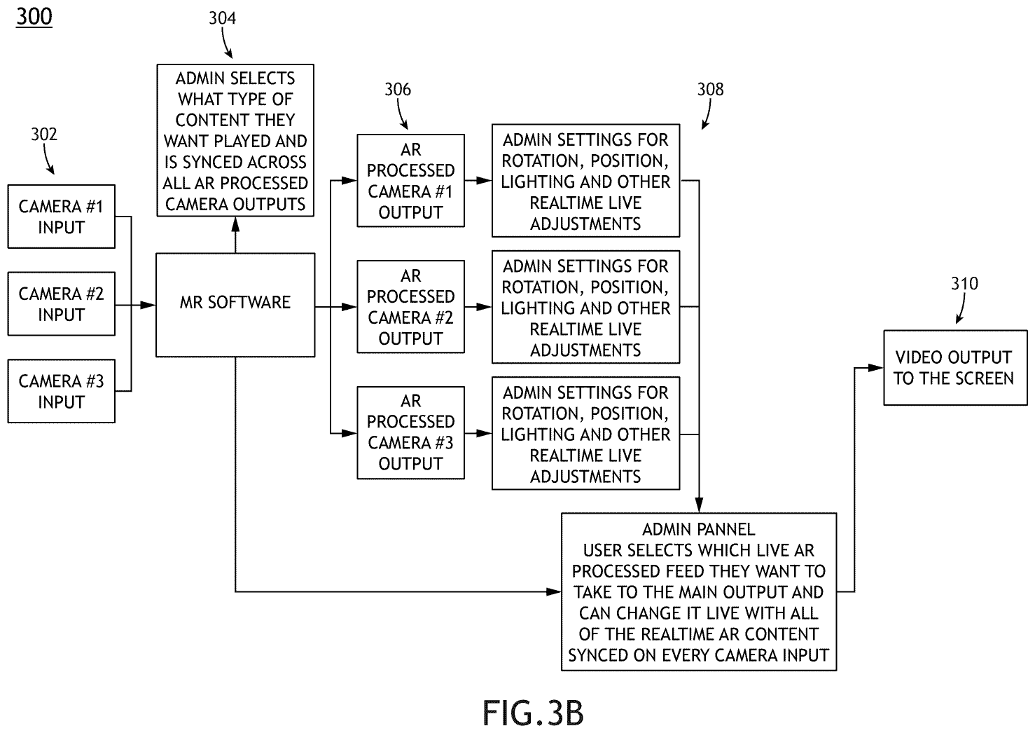

FIGS. 3A-3B illustrate flow charts depicting a method 300 for processing live camera feeds 204 to display the three-dimensional graphic on the event display device 228, in accordance with one or more embodiments of the present disclosure.

In embodiments, the method includes a step 302 of receiving the plurality of live camera feeds from the plurality of cameras in near real-time. For example, the one or more processors 212 may be configured to receive the plurality of live camera feeds 204 from the plurality of cameras 202 in near-real time. The plurality of cameras 202 may be arranged in one or more configurations/arrangements such that a variety of angles/positions are obtained. For example, in a non-limiting example, the camera configurations may include center, angled, side, top, rear, aerial, or the like.

In embodiments, the method includes a step 304 of receiving one or more augmented reality (AR) content selections from a user. The one or more AR content selections 216 may be based on the AR content 208 stored in the AR content database 206. For example, the one or more processors 212 may be configured to receive, from a user, one or more AR content selections 216 based on the AR content 208 stored in the AR content database 206. For instance, a user may select AR content 208 from the database 206 that the user would like to integrate into the live camera feed 204 through the user interface device 220.

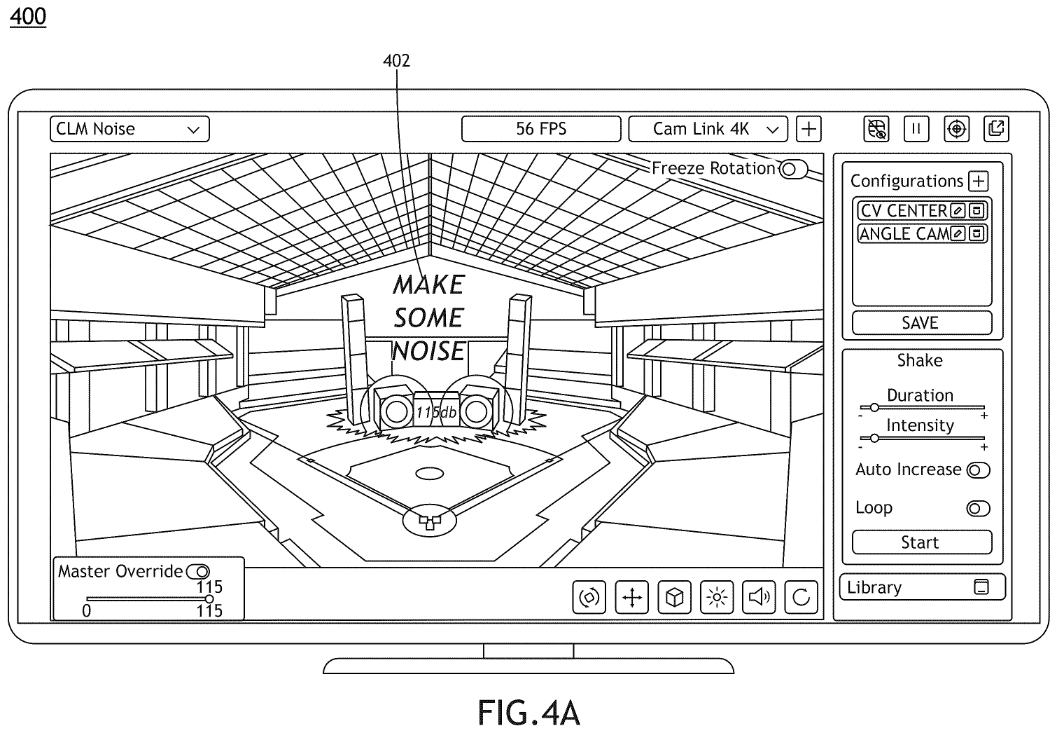

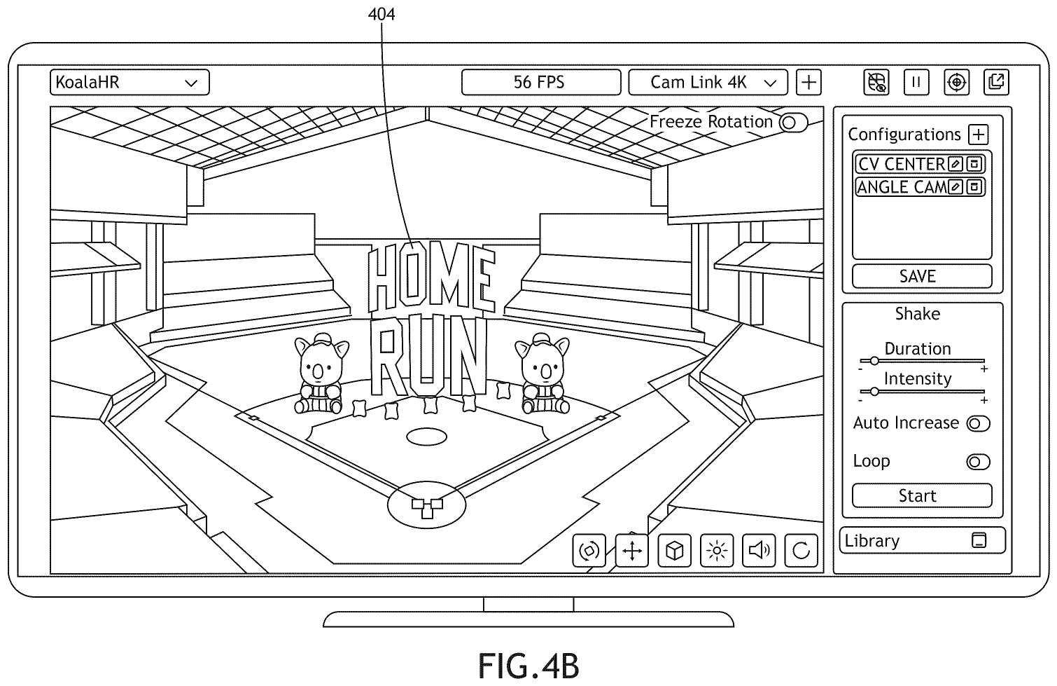

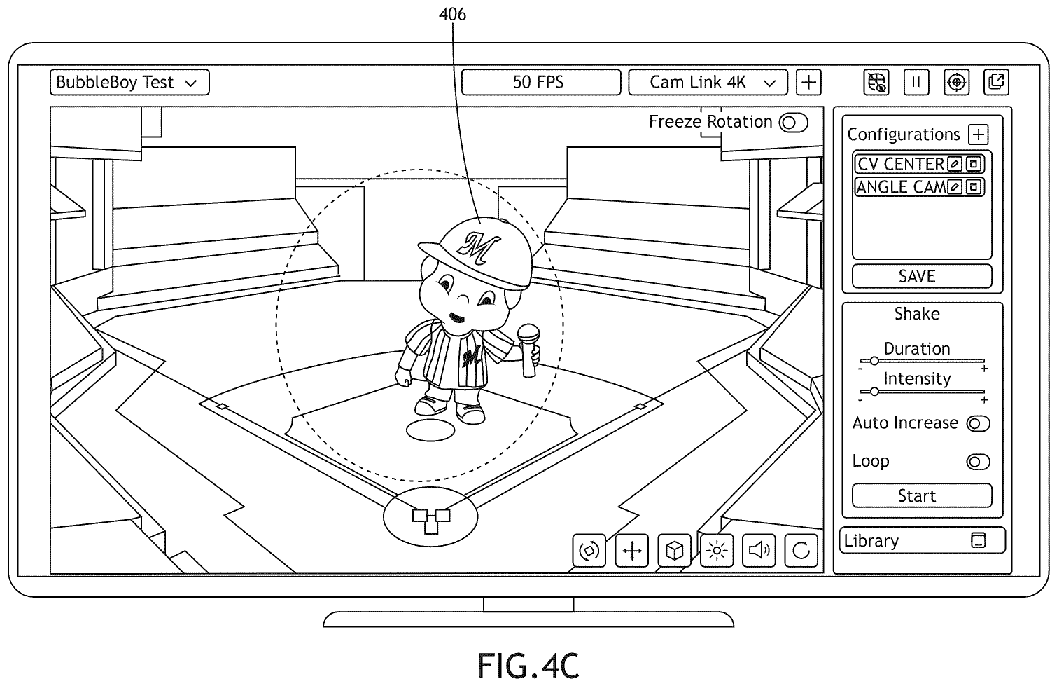

FIGS. 4A-4C illustrate graphical user interfaces (GUI) 400, 410, 420 including one or more digital elements, in accordance with one or more embodiments of the present disclosure. For example, The AR content selections 216 may include selecting a variety of digital elements 402, such as three-dimensional graphics, videos, interactive graphics, or the like to display on the event display device 228.

In a non-limiting example, as shown in FIG. 4A, the AR content selection 216 may include an interactive noise meter 402. The noise meter 402 may be tied to real audio from a microphone input or overridden by the MR system. In an additional non-limiting example, as shown in FIG. 4B, the AR content selection 216 may include a home run graphic 404. In an additional non-limiting example, as shown in FIG. 4C, the AR content selection 216 may include an animated team mascot 406.

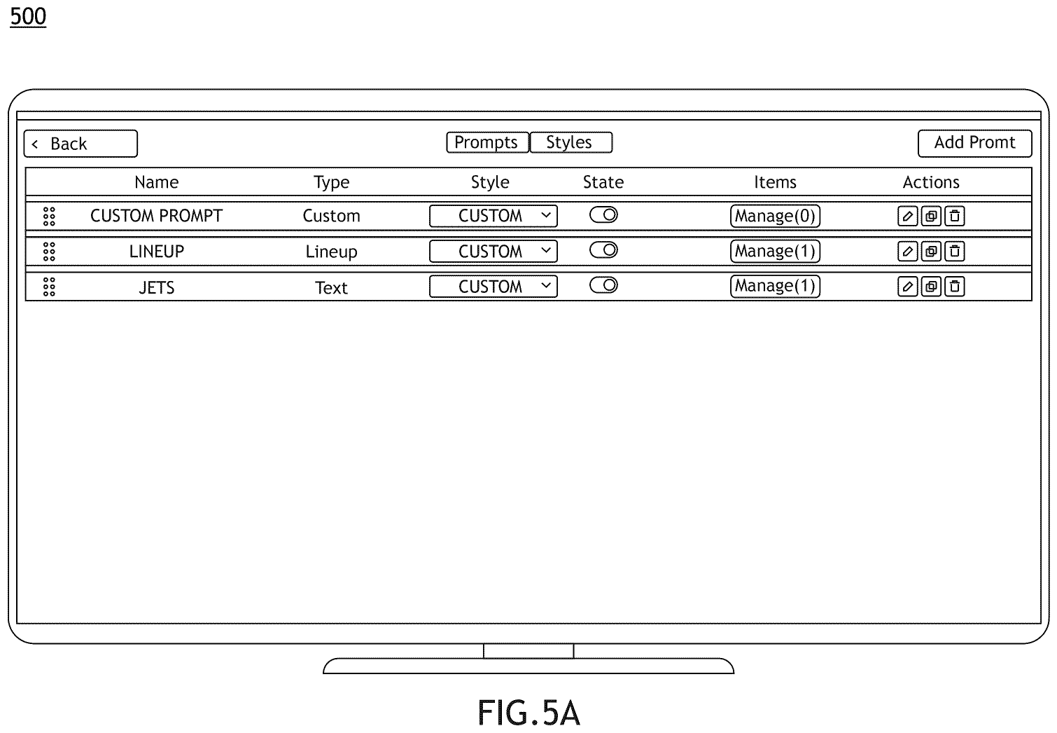

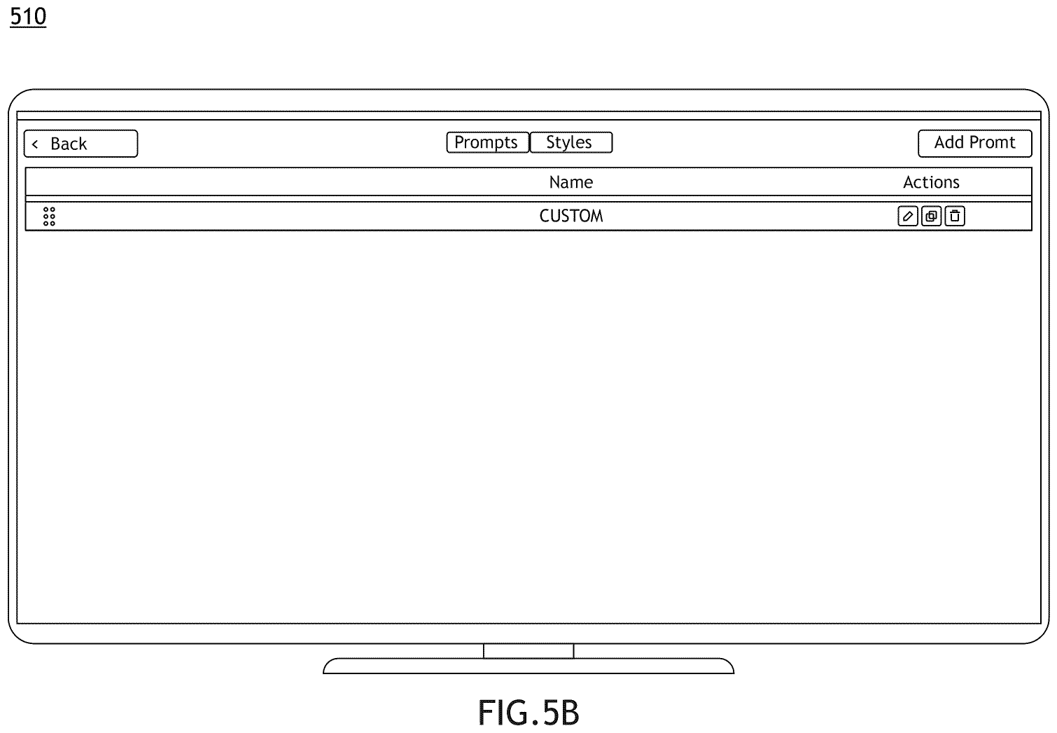

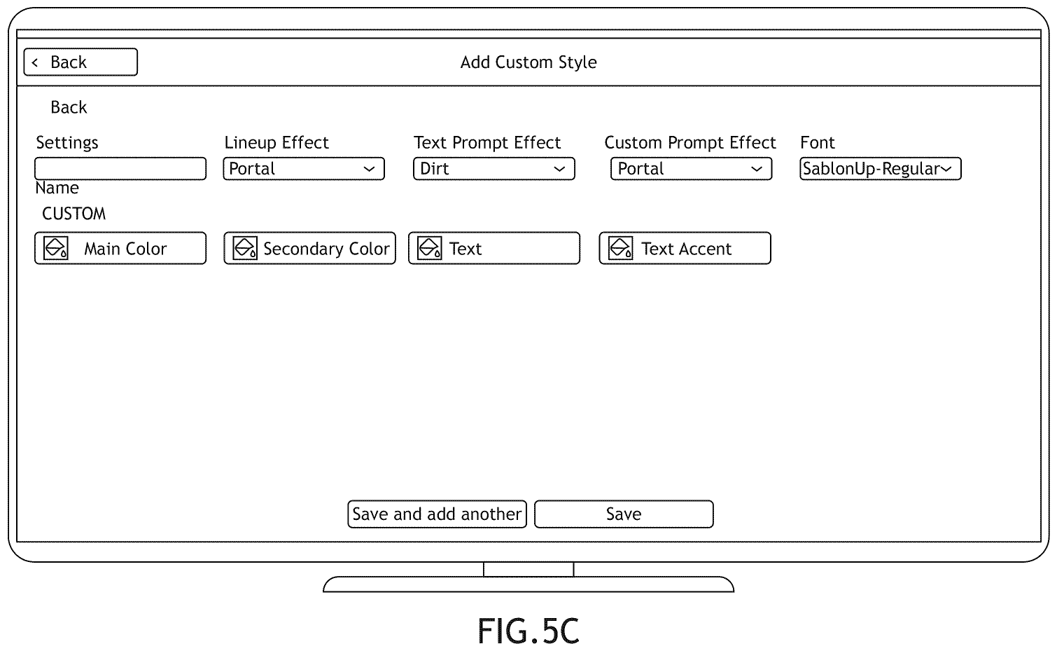

FIGS. 5A-5C illustrate customizable prompt graphical user interfaces (GUIs) 500, 510, 520, in accordance with one or more embodiments of the present disclosure.

In embodiments, the AR content 208 within the database 206 may be customizable. For example, the AR content selections 216 may include customizable digital elements. In this regard, the AR content 208 may be customized for a particular team, player, or the like. In a non-limiting example, a user may select customized graphics to represent a specific sports team (e.g., Jets).

In embodiments, the user may add a new prompt, or digital element template, to customize digital elements through to the MR library system 200, without the use of a third-party creator. For example, as shown in FIG. 5A, the user may choose a prompt type in a customizable prompt GUI 500, corresponding to a type of digital element, such as text, lineup, or the like. By way of another example, the user may also choose a custom prompt type.

The user may choose a specific style for the new prompt. For example, as shown in FIG. 5B, the user may adjust a prompt style in a customizable prompt style GUI 510. For instance, the specific styles for the prompt may be created by the user in a MR style configuration interface as shown in the GUI 510 of FIG. 5B. In this regard, as shown in FIG. 5C, the user may choose, using the GUI 520, a variety of properties such as main color, secondary color, text color, text accent, font, or effects. It is contemplated herein that the chosen effects may be saved to the platform as a specific style.

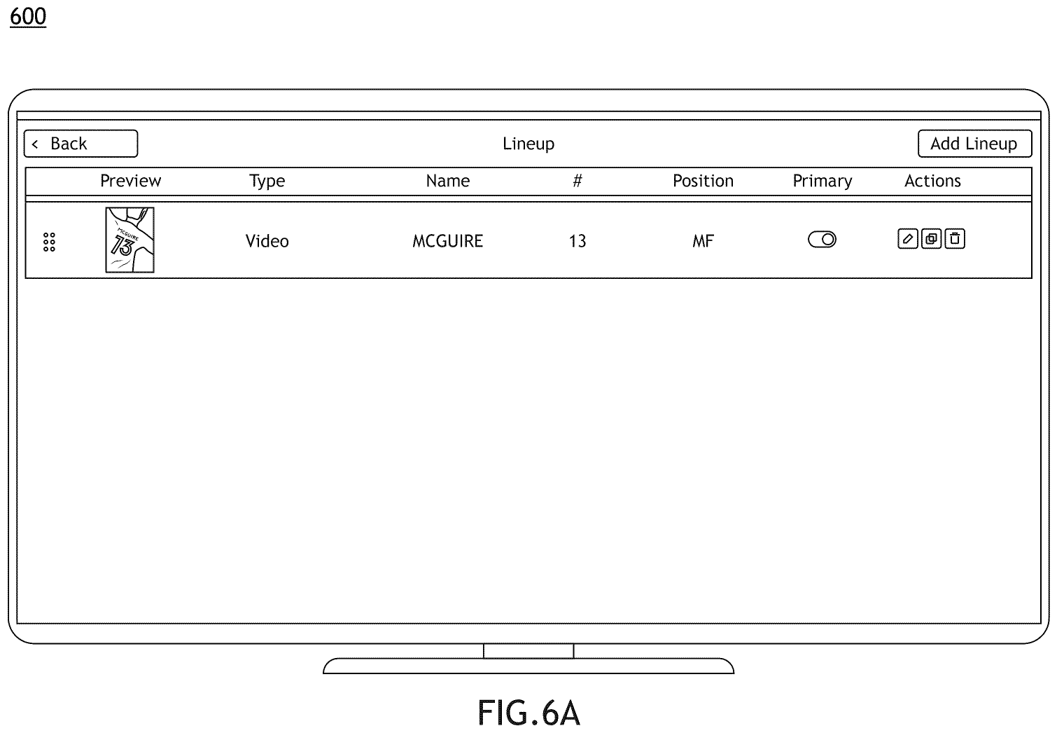

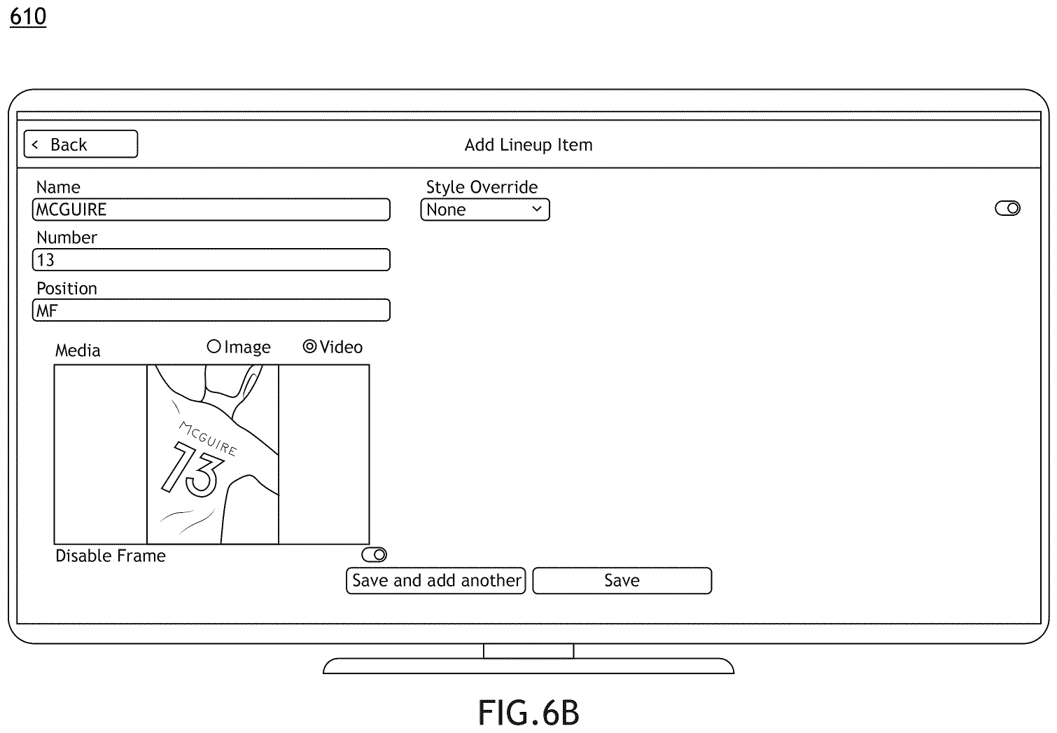

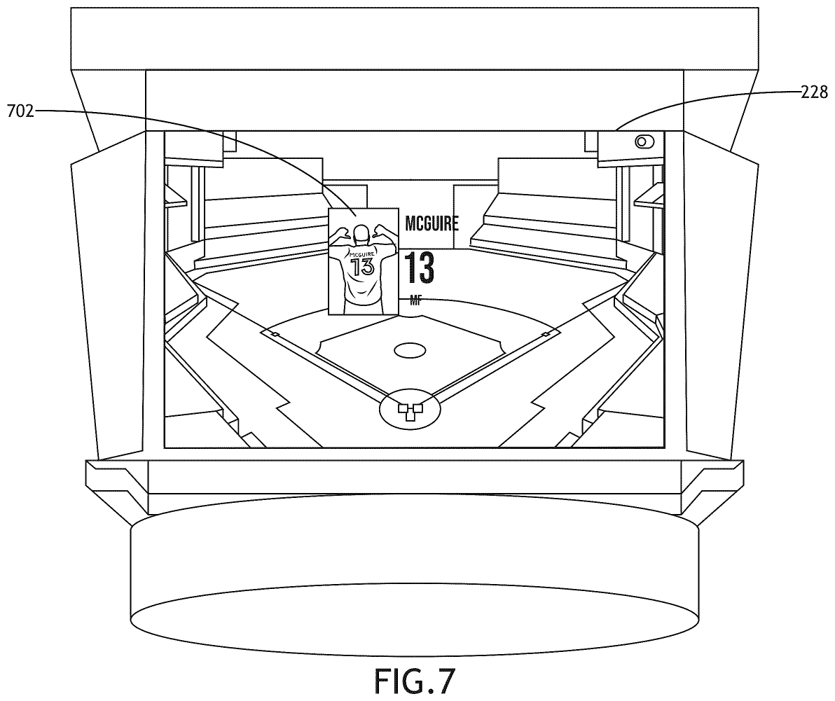

FIGS. 6A-6B illustrates customizable prompt builder graphical user interfaces (GUIs) 600, 610, in accordance with one or more embodiments of the present disclosure. FIG. 7 illustrates the event display device 228 (e.g., jumbotron) displaying the customized graphic 702, in accordance with one or more embodiments of the present disclosure.

The MR library system may include prompt builders for particular prompt types. For example, as shown in FIG. 6A, the MR library may include a prompt builder GUI 600 for a team lineup. For instance, as shown in FIG. 6B, the prompt builder may allow the user to input relevant information (e.g., name, position, jersey number, or the like) and include relevant media (e.g., image, video, or the like), using the GUI 610, for each entry that may be displayed. In this regard, as shown in FIG. 7, the prompt may be selected by the user as augmented reality content, processed, and integrated into the augmented reality process camera output, such that the customized graphic 702 is displayed on the event display device 228 (e.g., jumbotron).

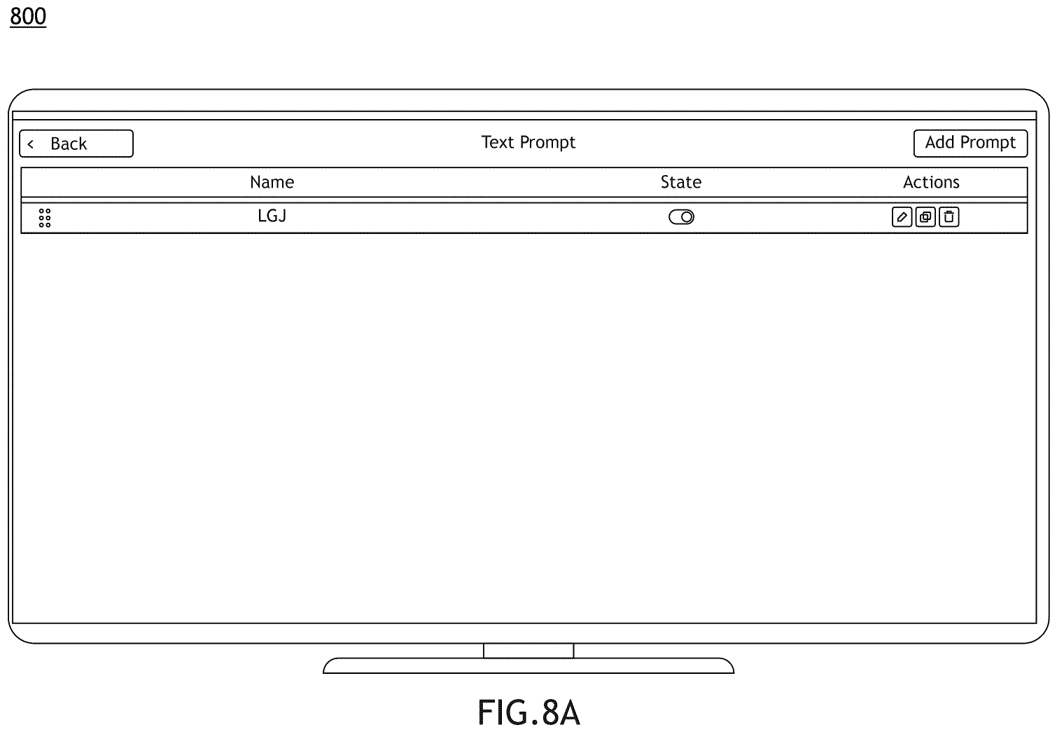

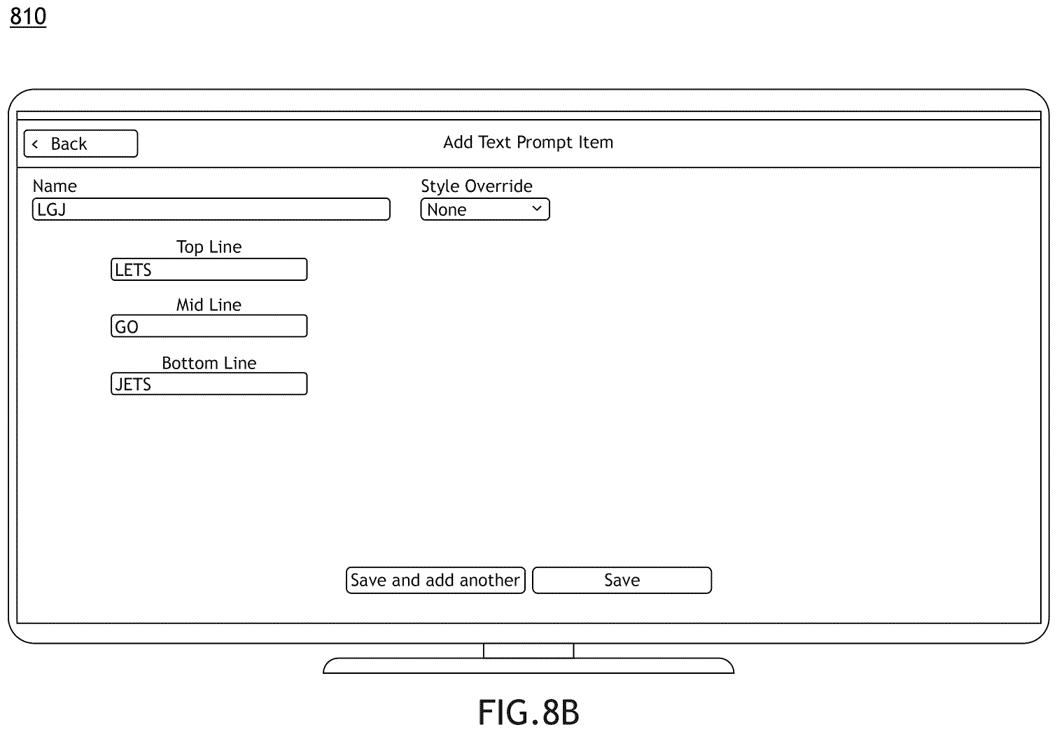

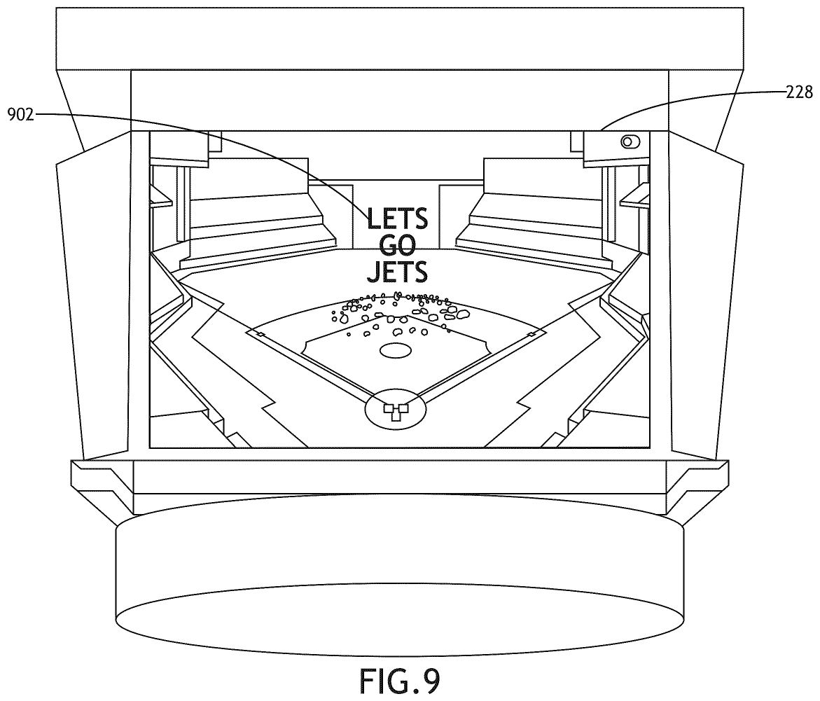

FIGS. 8A-8B illustrates customizable text prompt graphical user interfaces (GUIs) 800, 810, in accordance with one or more embodiments of the present disclosure. FIG. 9 illustrates the event display device 228 displaying the customized graphic 902, in accordance with one or more embodiments of the present disclosure.

In a non-limiting example, as shown in FIG. 8A, the MR library may include a prompt builder text GUI 800 for customizing text graphics. For instance, as shown in FIG. 8B, the prompt builder may allow the user to input relevant text and the configuration of the text (e.g., what row the text corresponds) in the GUI 810. In this regard, as shown in FIG. 9, the prompt may be selected by the user as augmented reality content, processed, and integrated into the augmented reality process camera output, such that the customized text graphic 902 may be displayed on the event display device 228 (e.g., jumbotron).

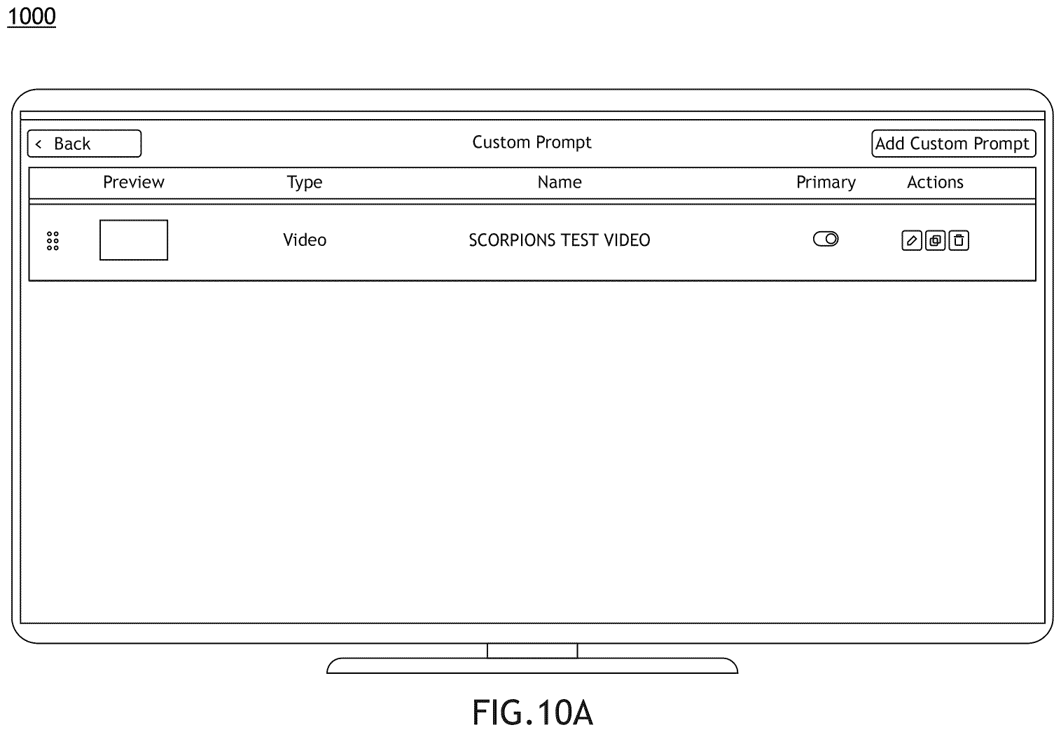

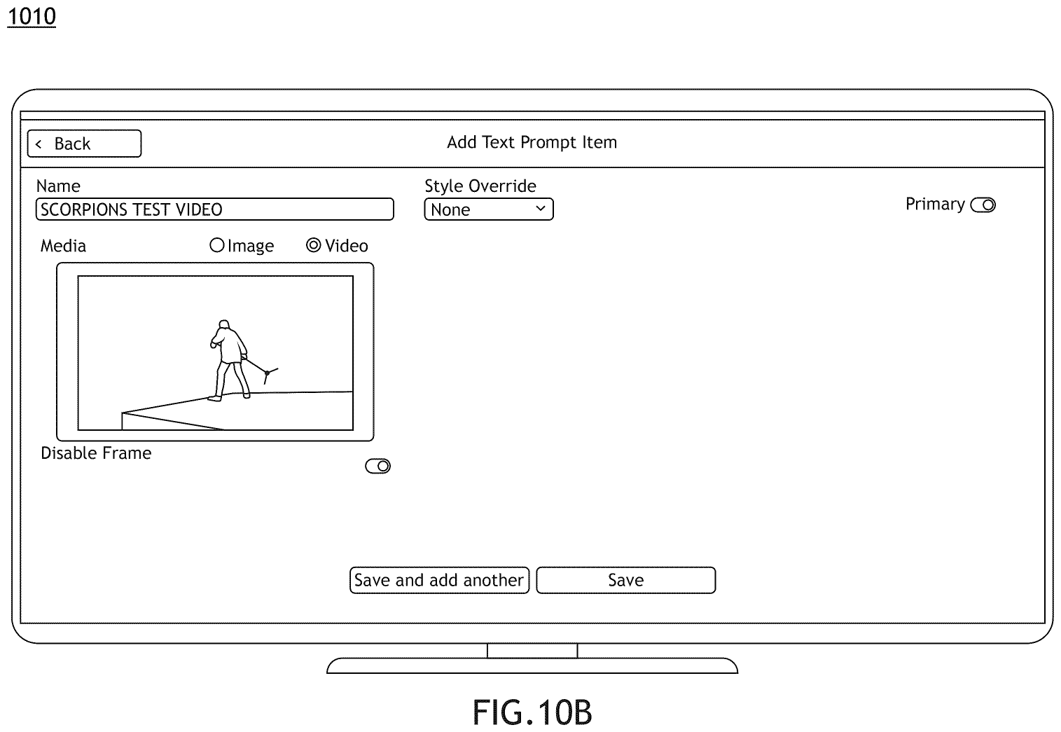

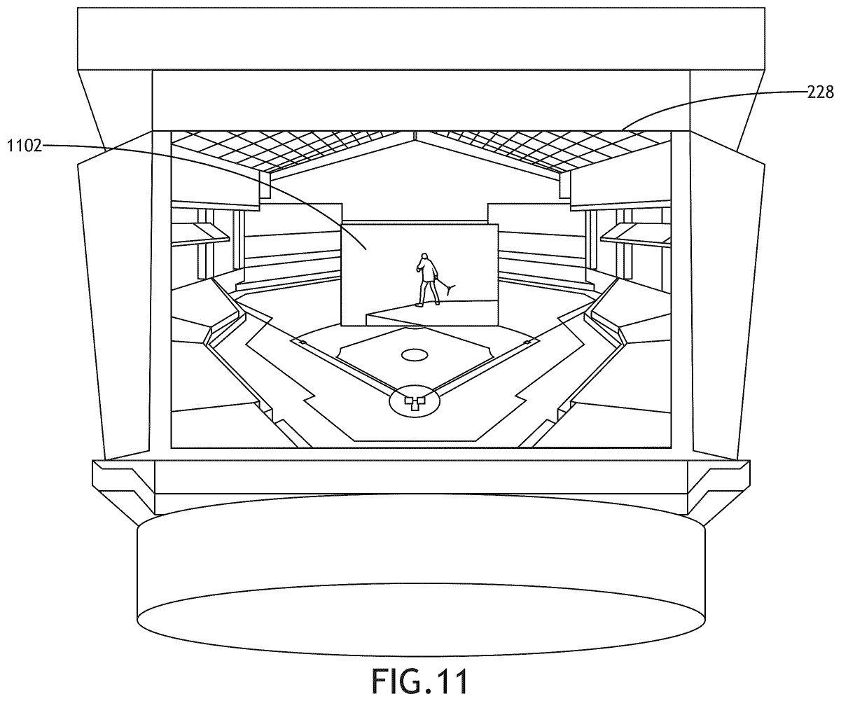

FIGS. 10A-10B illustrates customizable video prompt graphical user interfaces (GUIs) 1000, 1010, in accordance with one or more embodiments of the present disclosure. FIG. 11 illustrates the event display device 228 displaying the customized video graphic 1102, in accordance with one or more embodiments of the present disclosure.

The MR library may include a video prompt builder for generating customized video prompts. For example, as shown in FIG. 10A, the user may create a custom prompt, using the GUI 1000, to generate a customized media (e.g., video, image, or the like). For instance, as shown in FIG. 10B, the custom prompt builder GUI 1010 may allow a user to select the media type, media file, or the like. In this regard, as shown in FIG. 11, the prompt may be selected by the user as augmented reality content, processed, and integrated into the augmented reality process camera output, such that the event display device 228 may display the customized video graphic 1102.

In embodiments, the AR content selections 216 may further include selecting one or more parameters. For example, the augmented reality content selection may include selecting/adjusting positioning/configurations of the digital element on the live camera feed 204 (as shown in FIGS. 4A-4C). By way of another example, the AR content selection may include selecting/adjusting motions that the digital elements may undergo (e.g., shaking), the duration and intensity of motions, or the like (as shown in FIGS. 4A-4C).

In embodiments, the method includes a step 306 of generating a plurality of AR processed camera outputs for each live camera feed of the plurality of live camera feeds. The one or more AR selections 216 received from the user may be synced across each AR process camera output 218 of the plurality of AR processed camera outputs.

For example, the one or more processors 212 may generate a plurality of AR processed camera outputs 218 for each live camera feed 204 of the plurality of live camera feeds. In this regard, the one or more processors 212 may integrate the AR content selections 216 into each live camera feed 204, thereby creating the plurality of the AR processed camera outputs 218. As such, as shown in FIGS. 5A-11, the AR processed camera outputs 218 may include the AR content 216 selected by the user in the configuration selected by the user (in the step 304).

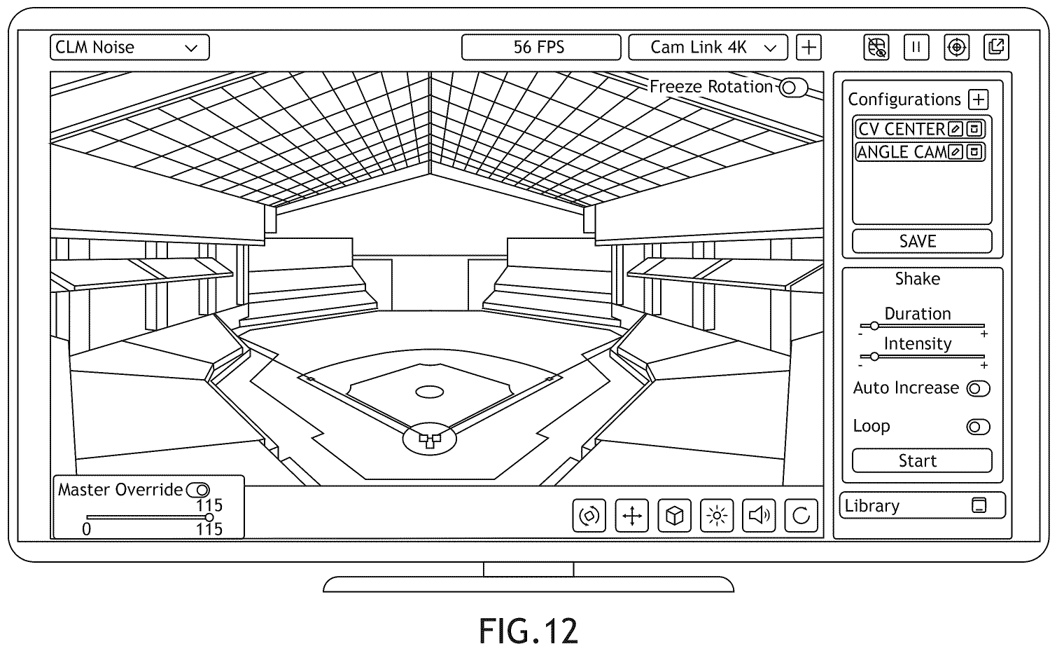

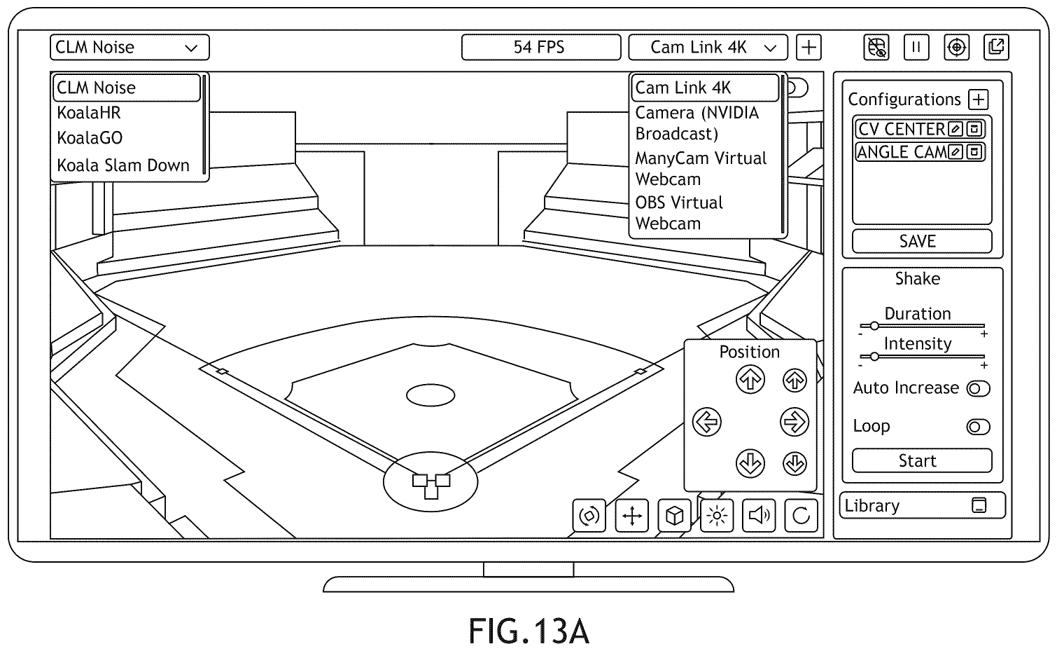

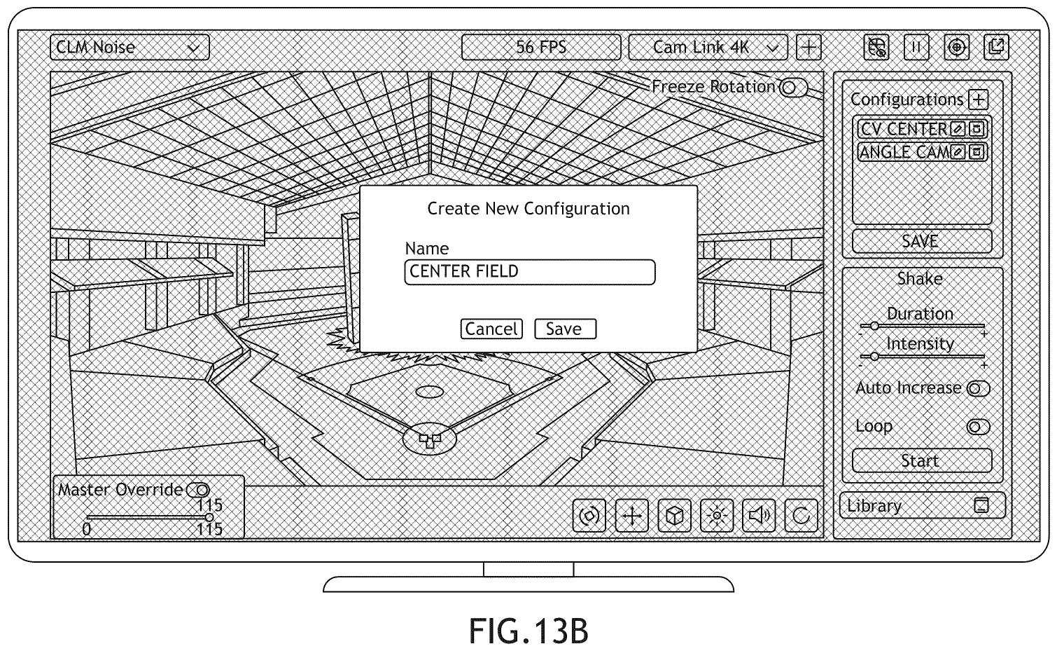

The one or more AR selections received from the user may be synced across each AR process camera output 218 of the plurality of AR processed camera outputs. For example, each live camera feed 204 may be processed using the same AR content selections 216 at the same time. It is contemplated herein that this allows the AR process camera output 218 associated with each selected live camera feed (as discussed below) to include the same AR content simultaneously. For example, as shown in FIGS. 12-13B, the user may switch between live camera feeds on an MR mainboard. For instance, the AR content can be viewed from the plurality of camera angles associated with each of the plurality of cameras and sent to the mainboard from each camera via a mainboard button. In this regard, as shown in FIGS. 13A-13B, each of the live camera feeds may have the augmented reality content integrated into the associated augmented reality process camera output, such that the user may seamlessly switch between the live feeds.

In embodiments, the method includes a step 308 of receiving a live augmented reality processed feed selection from the user. For example, the one or more processors may receive a live augmented reality processed feed selection 226 from the user based on the generated plurality of AR processed camera outputs 218.

The live AR processed feed selection 226 may be based on the generated plurality of AR processed camera outputs 218. For example, the one or more processors 212 may process the live camera feeds 204 as directed by the user through the interactive interface of the user device 220.

The interactive interface may allow the user to view each of the plurality of live camera feeds, adjust lighting, volume level and other video parameters. For example, as shown in FIG. 13A, the user may switch the live camera feed being viewed by selecting a different live camera feed from a graphical user interface (GUI) within the interactive interface. By way of another example, as shown in FIG. 13B, the live camera feed from one of the cameras may be set a predefined location, allowing live camera feed settings to be saved in the application for the specific location (e.g., a location on the field).

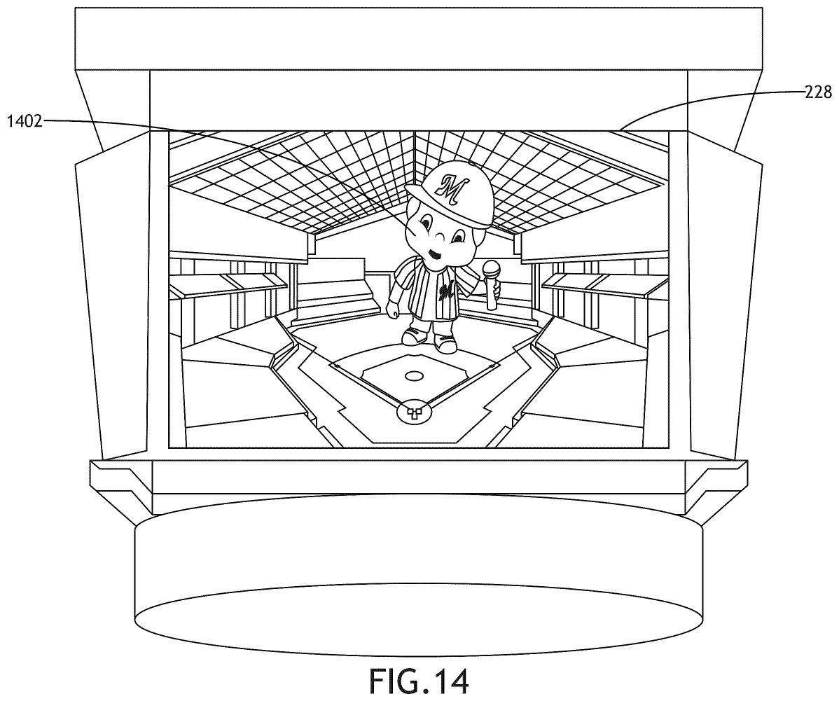

In embodiments, the method includes a step 310 of generating one or more control signals configured to cause the event display device to display a three-dimensional graphic. For example, as shown in FIG. 14, the one or more processors 212 may generate one or more control signals configured to cause the event display device 228 to display the three-dimensional graphic 1402 corresponding to the received live AR processed feed selection 226 on the event display device 228.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A mixed reality system comprising:
a controller communicatively coupled to a plurality of cameras, the controller including one or more processors configured to execute a set of program instructions stored in memory, the set of program instructions configured to cause the one or more processors to:
receive a plurality of live camera feeds from the plurality of cameras in near real-time;
receive one or more augmented reality content selections from a user based on augmented reality content stored in an augmented reality content database;
generate a plurality of augmented reality processed camera outputs for each live camera feed of the plurality of live camera feeds, wherein the one or more augmented reality content selections received from the user are synced across each augmented reality process camera output of the plurality of augmented reality processed camera outputs;
receive a live augmented reality processed feed selection from the user based on the plurality of augmented reality processed camera outputs generated; and
generate one or more control signals configured to cause an event display device to display a three-dimensional graphic corresponding to the live augmented reality processed feed selection received.

2. The mixed reality system of claim 1, further comprising:
a user device including a display and a user input device, wherein the user input device is further configured to receive the live augmented reality processed feed selection from the user.

3. The mixed reality system of claim 2, wherein the live augmented reality processed feed selection comprises at least one of:
a live feed camera selection, a lighting parameter selection, or a volume level selection.

4. The mixed reality system of claim 2, wherein the user input device is configured to receive the one or more augmented reality content selections from the user.

5. The mixed reality system of claim 4, wherein the three-dimensional graphic includes a customizable digital element.

6. The mixed reality system of claim 5, wherein the user input device is configured receive one or more customized digital element selections from the user for the three-dimensional graphic.

7. The mixed reality system of claim 6, wherein the one or more customized digital element selections comprise:
a sports team selection, wherein the sports team selection adjusts the augmented reality content stored in the augmented reality content database based on the sports team selection.

8. The mixed reality system of claim 6, wherein the one or more customized digital element selections comprise:
a player selection, wherein the player selection adjusts the augmented reality content stored in the augmented reality content database based on the player selection.

9. The mixed reality system of claim 4, wherein the one or more augmented reality content selections from the user comprise at least one of:
a digital element positioning parameter selection, a digital element duration selection, or a digital element intensity selection.

10. The mixed reality system of claim 1, wherein the augmented reality content database is a remote database communicatively coupled to the controller.

11. The mixed reality system of claim 2, wherein the augmented reality content database is stored in the user device.

12. The mixed reality system of claim 1, wherein the event display device comprises a jumbotron.

13. A mixed reality system comprising:
a plurality of cameras, wherein the plurality of cameras are configured to generate a plurality of live camera feeds of a live event in near real-time;
an augmented reality content database including augmented reality content stored in the augmented reality content database; and
a controller communicatively coupled to the plurality of cameras and the augmented reality content database, the controller including one or more processors configured to execute a set of program instructions stored in memory, the set of program instructions configured to cause the one or more processors to:
receive the plurality of live camera feeds from the plurality of cameras in near real-time;
receive one or more augmented reality content selections from a user based on the augmented reality content stored in the augmented reality content database;
generate a plurality of augmented reality processed camera outputs for each live camera feed of the plurality of live camera feeds, wherein the one or more augmented reality content selections received from the user are synced across each augmented reality process camera output of the plurality of augmented reality processed camera outputs;
receive a live augmented reality processed feed selection from the user based on the plurality of augmented reality processed camera outputs generated; and
generate one or more control signals configured to cause an event display device to display a three-dimensional graphic corresponding to the live augmented reality processed feed selection received.

14. The mixed reality system of claim 13, further comprising:
a user device including a display and a user input device, wherein the user input device is further configured to receive the live augmented reality processed feed selection from the user.

15. The mixed reality system of claim 14, wherein the live augmented reality processed feed selection comprises at least one of:
a live feed camera selection, a lighting parameter selection, or a volume level selection.

16. The mixed reality system of claim 14, wherein the user input device is configured to receive the one or more augmented reality content selections from the user.

17. The mixed reality system of claim 16, wherein the three-dimensional graphic includes a customizable digital element.

18. The mixed reality system of claim 17, wherein the user input device is configured to receive one or more customized digital element selections from the user for the three-dimensional graphic.

19. The mixed reality system of claim 18, wherein the one or more customized digital element selections comprise:
a sports team selection, wherein the sports team selection adjusts the augmented reality content stored in the augmented reality content database based on the sports team selection.

20. The mixed reality system of claim 18, wherein the one or more customized digital element selections comprise:
a player selection, wherein the player selection adjusts the augmented reality content stored in the augmented reality content database based on the player selection.

21. The mixed reality system of claim 16, wherein the one or more augmented reality content selections from the user comprise at least one of:
a digital element positioning parameter selection, a digital element duration selection, or a digital element intensity selection.

22. The mixed reality system of claim 13, wherein the augmented reality content database is a remote database communicatively coupled to the controller.

23. The mixed reality system of claim 14, wherein the augmented reality content database is stored in the user device.

24. The mixed reality system of claim 13, wherein the event display device comprises a jumbotron.

25. A method comprising:
receiving a plurality of live camera feeds from a plurality of cameras in near real-time;
receiving one or more augmented reality content selections from a user based on augmented reality content stored in an augmented reality content database;
generating a plurality of augmented reality processed camera outputs for each live camera feed of the plurality of live camera feeds, wherein the one or more augmented reality content selections received from the user are synced across each augmented reality process camera output of the plurality of augmented reality processed camera outputs;
receiving a live augmented reality processed feed selection from the user based on the plurality of augmented reality processed camera outputs generated; and
generating one or more control signals configured to cause an event display device to display a three-dimensional graphic corresponding to the live augmented reality processed feed selection received.
